(19) United States
(12) Patent Application Publication
(10) Pub. No.: US 2007/0169079 A1
(43) Pub. Date: Jul. 19, 2007

(54) Software update management

(75) Inventors: Bryan R. Keller, Redmond, WA (US); Sobia Tariq, Seattle, WA (US); Anna C. Bell, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/269,332

(22) Filed: Nov. 8, 2005

(51) Int. Cl. G06F 9/44

(52) U.S. Cl. 717/168

(57) ABSTRACT

Generating a software update catalog may involve accessing resource identifiers. Each resource identifier may identify a location of a portion of update metadata corresponding to a respective program, where the portions of update metadata include information for determining whether to apply their respective updates. The resource identifiers may be used to import the portions of update metadata, and the software update catalog can be generated based on the imported portions of update metadata. Furthermore, a user interface (UI) may be displayed for authoring an update. The UI may allow a user to define the update and signature information by which a computer can be scanned to determine whether the update has been installed and/or whether the update is applicable. An update by generating a portion of update metadata that includes the information that identifies the update and that includes the scan information.

### BACKGROUND

Systems exist for managing software updates. Such systems discover what software is installed on a computer, as identified, for example, by make, manufacturer, version, or other indicia for relating a software product or program to relevant updates. Updates may be for security purposes, bug fixes, enhancements, or other types of upgrades. Some update management systems include features for managing software updates across an enterprise's IT (information technology) infrastructure, in which case a large number of computers may be scanned for a large number of different updates.

Most update management systems use a master catalog or manifest, which contains a list of various updates that are available and how to identify whether they have been applied to a computer. Identified updates may then be applied. However, to date, such update catalogs have been closed and inflexible. Administrators using update management systems have not been able to manage updates from different vendors, and aggregation of update information from multiple vendors has not been possible.

There is a need for tools and techniques for efficient management and control of software updates.

### SUMMARY

The following summary is included only to introduce some concepts discussed in the Detailed Description below. This summary is not comprehensive and is not intended to delineate the scope of protectable subject matter, which is set forth by the claims presented at the end.

Generating a software update catalog may involve accessing resource identifiers. Each resource identifier may identify a location of a portion of update metadata corresponding to a respective program, where the portions of update metadata include information for determining whether to apply their respective updates. The resource identifiers may be used to import the portions of update metadata, and the software update catalog can be generated based on the imported portions of update metadata. Furthermore, a user interface (UI) may be displayed for authoring an update. The UI may allow a user to define the update and signature information by which a computer can be scanned to determine whether the update has been installed and/or whether the update is applicable. An update by generating a portion of update metadata that includes the information that identifies the update and that includes the scan information.

Many of the attendant features will be more readily appreciated by referring to the following detailed description considered in connection with the accompanying drawings.

### DESCRIPTION OF THE DRAWINGS

Like reference numerals are used to designate like parts in the accompanying Drawings.

FIG. 1 shows a software update management system.

FIG. 2 shows a tool 140 for managing software updates.

FIG. 3 shows import, authoring, and publishing processes for an update metadata management tool.

FIG. 4 shows an example of a main user interface for an update management tool.

FIG. 5 shows some interface elements for configuring update metadata imports.

FIG. 6 shows a process and interface elements for actually importing update metadata files identified previously by user input and/or identified automatically.

FIG. 7 shows a process and user interface for viewing details about a software product with which a number of software updates may be associated.

FIG. 8 shows a process and interface for displaying detail of an update.

FIGS. 9 and 10 show some user interface panels for authoring an update.

FIG. 11 shows a scheme for securing update catalogs generated with an update management tool.

FIGS. 12 and 13 show examples of update metadata or catalogs.

### DETAILED DESCRIPTION

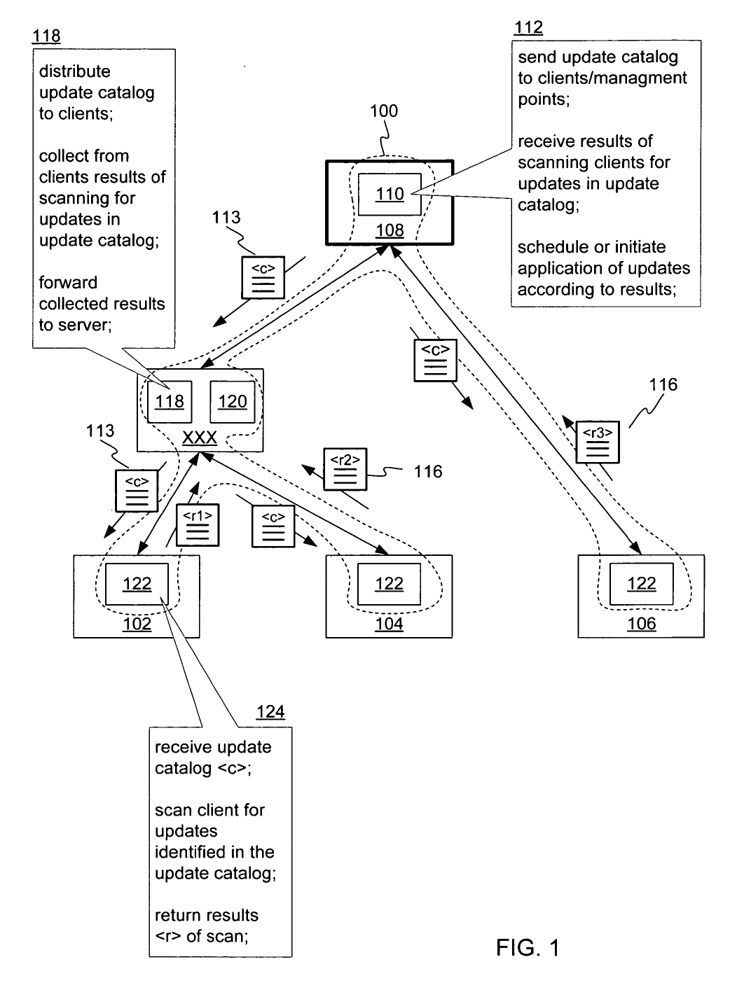

FIG. 1 shows a software update management system 100. The update management system 100 may be a collection of components (see components within dashed line). The goal of the update management system 100 is to scan client computers 102, 104, 106 for software updates that may be applicable thereon. The server, clients, and other nodes communicate using a data network. A server 108 is the main point of control for the update management system 100. The server 108 may have an update management module 110 performing various functions, including a process 112 of distributing an update catalog 113 to clients 102, 104, 106 (or management points 114, to be discussed), receiving results 116 of scanning for the updates described in the catalog, and possibly scheduling or initiation application of those updates identified by results 116 of the scanning.

The update management system 100 may involve simply a single server 108, or it may be part of a larger multi-node systems management framework. Such a framework may involve intermediary nodes such as management point 114. A management point 114 may perform a process 188 of receiving a catalog 113 from the server 108, forwarding or distributing it to the clients for which it is responsible (e.g., clients 102, 104), collecting information from its clients, and forward the collected results to the server 108. It may be convenient to divide the functionality of a management point 114 into a logic component 118 for carrying out the management functions delegated by the server 108, and a storage component 120 for storing update catalogs, scan results, update packages (to be applied to clients), and so on. These functions can be split among different computers.

Whether the update management system 100 uses an intermediating level or not, clients 102, 104, and 106 are scanned for updates. For this purpose, a client scanner 122 may be provided for each client. The client scanner 122 performs a process 124 of receiving or accessing the update catalog 113, scanning the client for updates identified in the catalog, and returning results of the scan. Scanning for an update usually involves checking to see whether the software to which the update relates is installed on the computer, and if it is, checking for signs (provided by the catalog) indicating whether the update has been applied. Such signs may be, for example, the existence or version of a file, the existence or value of a system configuration setting (e.g., a registry setting), the name of file system directory, the size/checksum of a particular file, information about an MSI (Microsoft Windows Installer) or other type of update package, or combinations of such signs, sometimes referred to as an update signature.

Although having a client scan itself for updates is convenient, a client can also be scanned remotely. For example, management point 114 or server 108 could, given sufficient access to clients 102, 104, 106, analyze the files, registry or configuration settings, and other data on the clients.

In sum, the update management system 100 may be viewed as any system that allows an administrator to specify an update catalog, control the scanning of client computers for updates in the catalog, and possibly apply any identified updates where they are needed. For examples of such systems, see various products from Shavlik Technologies, Microsoft Corporation (Systems Management Server 2003, patch management features), St Bernard Software (UpdateEXPERT), and possibly others.

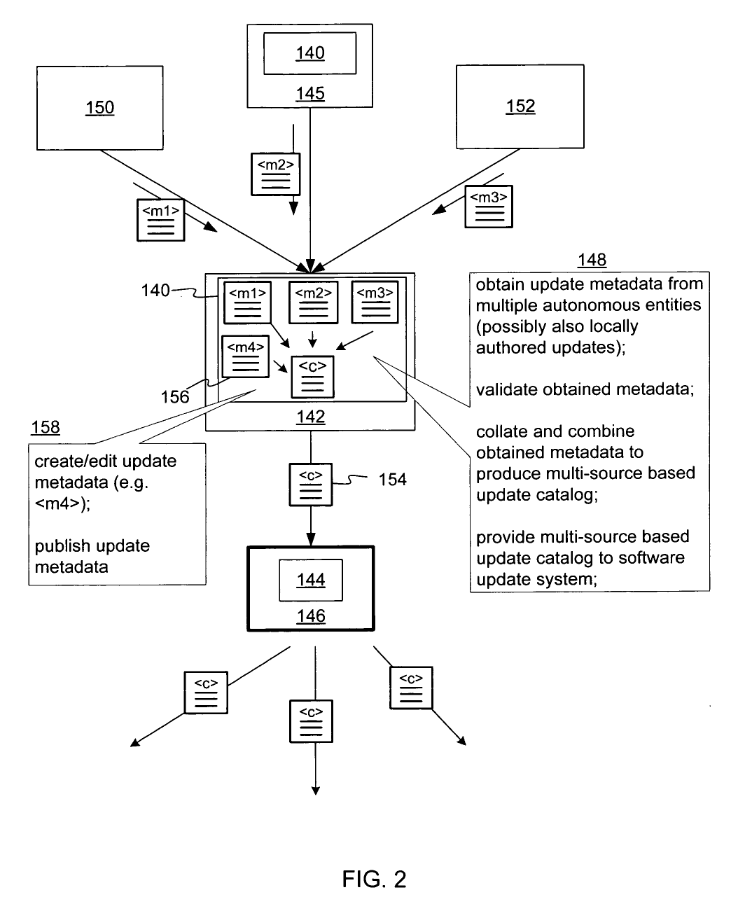

FIG. 2 shows a tool 140 for managing software updates. Tool 140 or variations thereof may reside on a variety of hosts, such as a local host 142, or a remote host 145 (“local” and “remote” are relative to an administrator who may use such a tool). As will be explained, the tool 140 has different functions, including managing the collecting of software update metadata from other externally authored and hosted sources. Another function of tool 140 is local authoring of update metadata for publishing to other entities (the public, the Internet, etc.) or to a local update management system 144 (similar to update management system 100), which is shown at least on a server 108/146 (clients or other possible components are not shown).

As mentioned, the tool 140 may be configured to perform a process 148 for collecting update metadata from disparate sources. This may involve obtaining update metadata from various entities on the Internet. For example, update metadata <ml> may be pulled from an FTP (file transfer protocol) server 150 of a software publishing company that makes updates to its software products available to the public. Another update metadata, <m2>, may be obtained from a web server on remote host 145. Yet another update metadata file <m3> may be obtained from another server 152 of some other autonomous entity such as a third party that publishes update metadata for various software vendors. The various pieces of update metadata may be formatted or tagged (e.g., using XML) according to some common schema or format. A common schema or format allows a network of entities to freely share information about their updates. It also allows tool 140's process 148 to validate imported update metadata, and then collate and combine external update metadata to produce a master update catalog 154 (<c>) that can be provided to local software update system 144. Local update metadata 156 (<m4>) may also be incorporated into the master update catalog 154. The pieces of update metadata will provide details about what software they respectively correspond to, signatures for how to identify such software and whether it has been updated already, where a corresponding update package is located, and so on.

The tool may also perform a process 158 for authoring a piece of software update metadata such as local update metadata 156. Although explained in detail later, this authoring process 158 involves creating a piece of update metadata and publishing it for public or private consumption. In the example in FIG. 2, tool 140 on external host 145 has been used to create external update metadata <m2>.

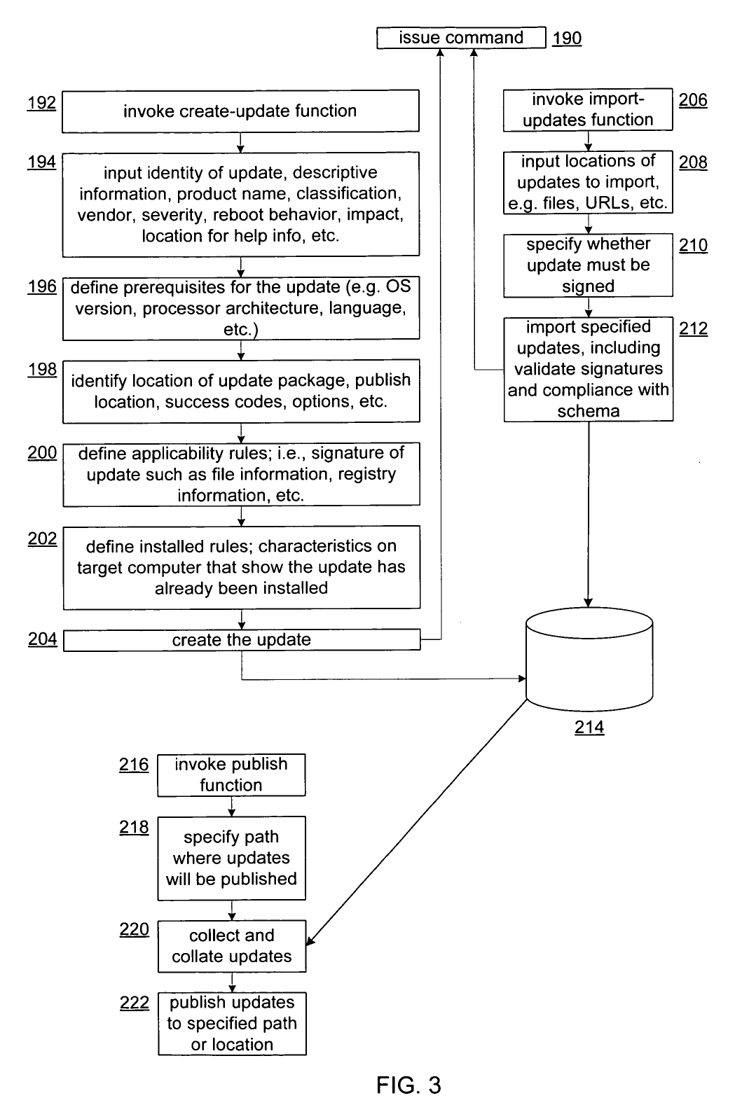

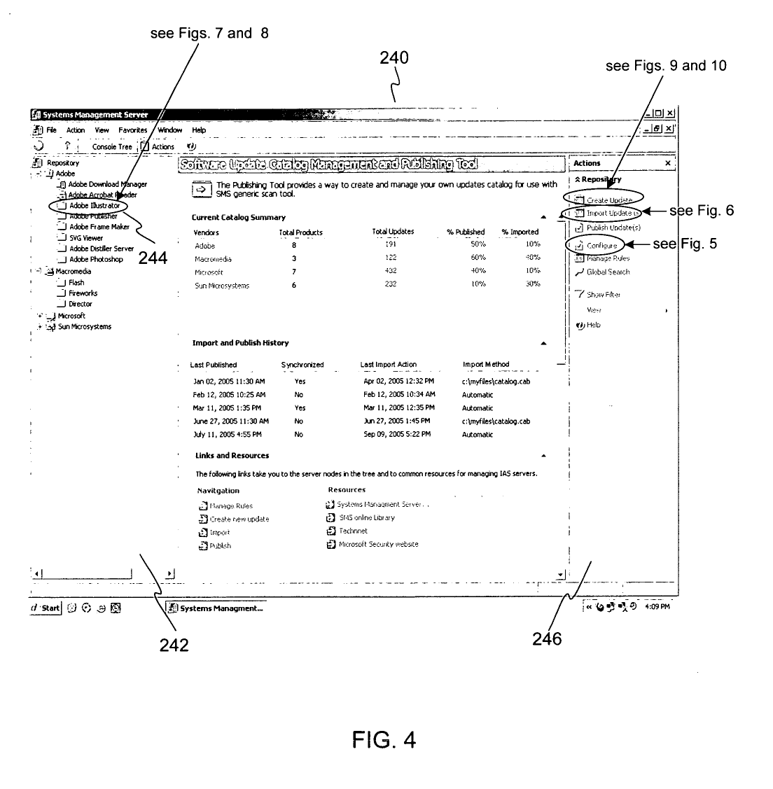

FIG. 3 shows import, authoring, and publishing processes for an update metadata management tool. The tool may have a user interface as discussed later with reference to FIG. 4. Via the user interface, a user may issue 190 a command to invoke some function of the tool. When the create-update function is invoked 192 to create a new piece of update metadata, the user is prompted to input 194 update information, some examples of which include the identity of the new update, descriptive information, a product name, a classification (e.g., security, maintenance), a vendor, a severity level, a reboot behavior (whether the update requires the target computer to be rebooted), location for related information such as help information, and so on. The user may then be then be allowed to define 196 prerequisites for the new update (conditions under which the update might be applicable), such as an OS version, a processor architecture, etc. Because most updates are ultimately intended to actually update or upgrade files, components, or data of a software program or product, the user is also allowed to identify 198 a location of an update package, and perhaps also a location to publish the new update, success codes that may be returned from an update installation process at a client.

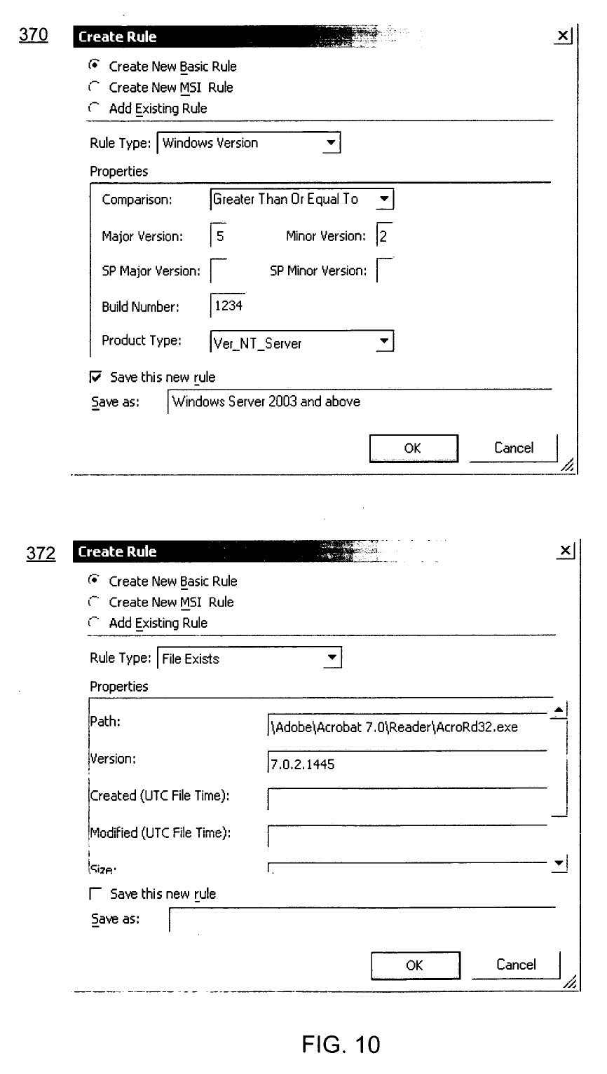

A notable part of an update also defined by the user 200 is indicia of whether the software product or program to be updated is actually installed or present on the target computer. This information may involve any indicia of whether a program is installed; files, registry entries, installation packages, etc. Another important part of most updates is the signature by which the need for the update is identified; information indicating whether the update is applicable on the target computer. Thus, the create-update function of the tool also includes a step for defining 202 applicability rules; a signature for identifying whether the new update is applicable. Applicability rules may include information such as filenames, configuration data, file or library versions, or other indicia. These atomic pieces of information can be used to construct possibly complex applicability rules, which will be discussed in greater detail later with reference to FIG. 10. Finally, the new update is created 204 in the form of a file of metadata or some other document that captures the information inputted by the user. It should be noted that various pieces of the information for an update might also be obtained automatically. For example, a signature might be extracted from the binary package for actually updating a program.

Referring again to FIG. 3, if the user issues 190 a command to invoke an import-updates function 206, then the user is prompted to input 208 locations of updates to import. Such locations may be local files, network file paths, URLs to external resources, and so on. The tool may also ask the user to specify 210 whether the updates at the inputted 208 locations must be authenticated, for example by a digital certificate signed by a certificate authority. Finally, the updates at the inputted 208 locations are imported 212, using a protocol (e.g., HTTP) if it has been specified or inputted 208. The importing 212 may involve validating digital certificates and checking that the imported metadata conforms to a common schema or formatting convention. Whether an update metadata file is authored or imported, the update metadata is stored in a repository 214.

A user can also invoke 216 a publish function to publish update metadata to a local update management system. A path is specified 218 for where the updates will be published; a file or network path where a new update catalog will be sent to when it is published. Next, the updates (pieces of update metadata) are collected from the repository 214 and collated into an update catalog (e.g., update catalog <m4>156) which is published 222 to the specified 218 path or location. The catalog is published as XML or the like, and may conform to the same standard schema or format used by imported 212 update metadata (e.g. <ml> or <m2>) or authored 194-204 update metadata (e.g. <m4>156). When catalogs and update descriptions are standardized in this way, a published 222 catalog can not only be used for internal update scanning, but it can also be made available to other entities or institutions for them to import and incorporate into their own update catalog.

In another embodiment, updates are not separately imported and stored before a catalog is generated and published. Rather, when a publish-catalog function is invoked by a user, the tool then automatically imports whatever update metadata it is aware of (either by previous manual configuration or automatically based on prior import experience). Furthermore, merging of various imported and locally authored update metadata files can be done in any number of ways. With well constructed metadata, the update metadata can be essentially concatenated into one large metadata that becomes the update catalog. Or, update metadata can be processed to filter out updates that do not match certain filtering criteria such as specific applicability or prerequisite criteria. This criteria can even be subdivided, for example according to different subsets of client computers that will be scanned for updates, in which case multiple catalogs are published and distributed to respective parts of update management system 100.

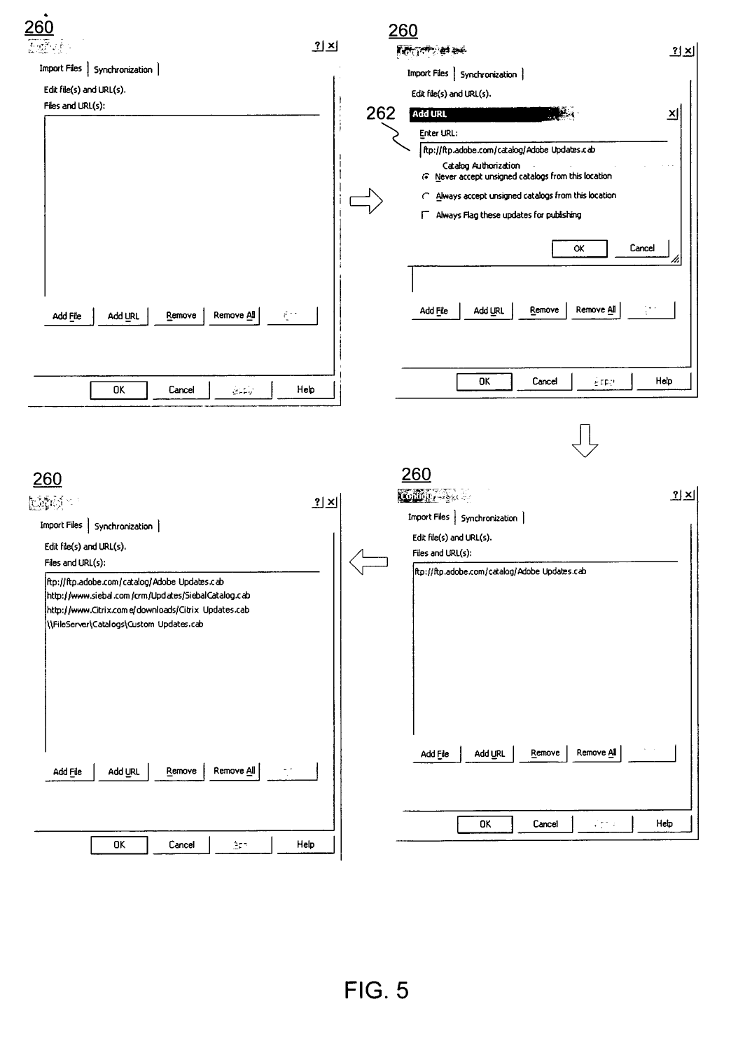

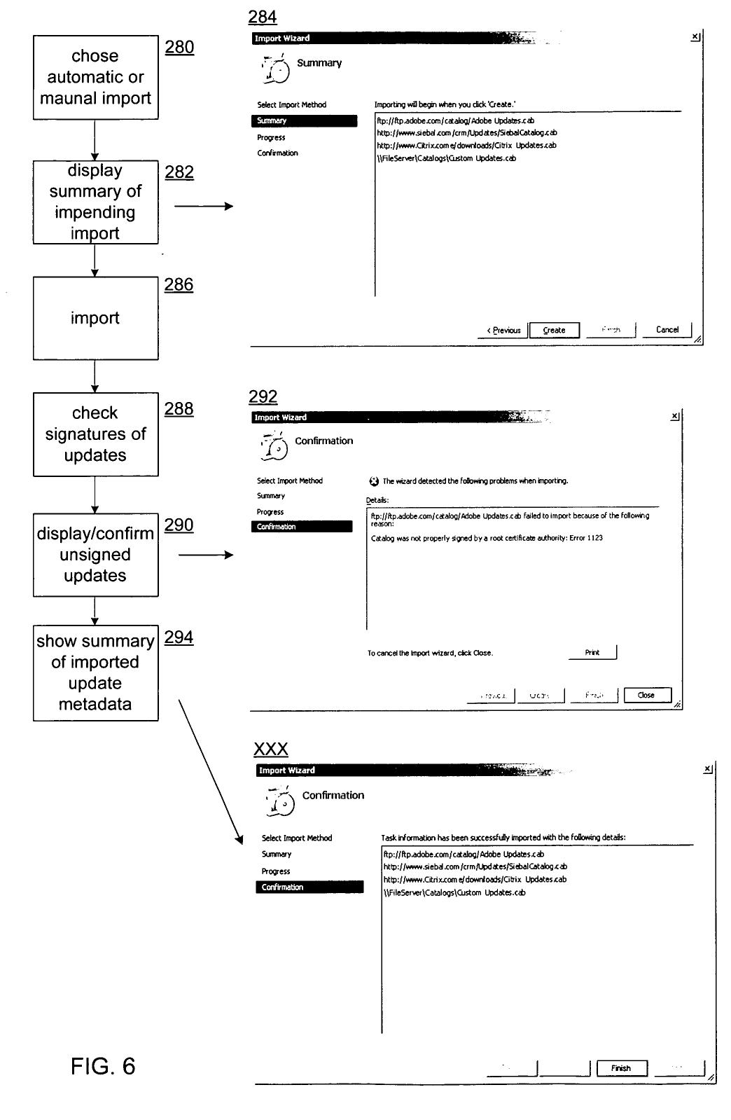

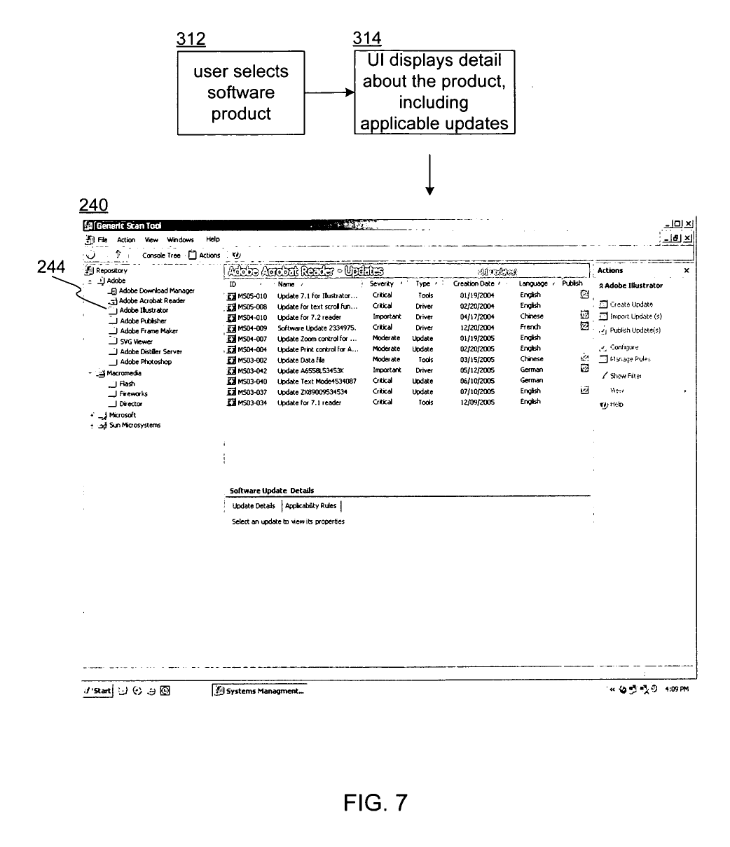

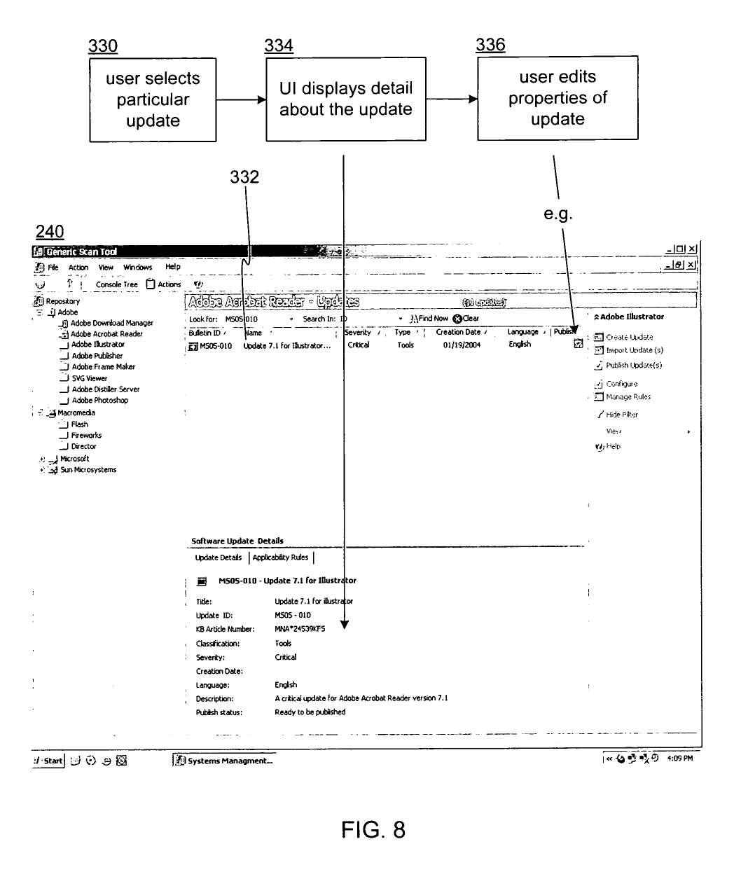

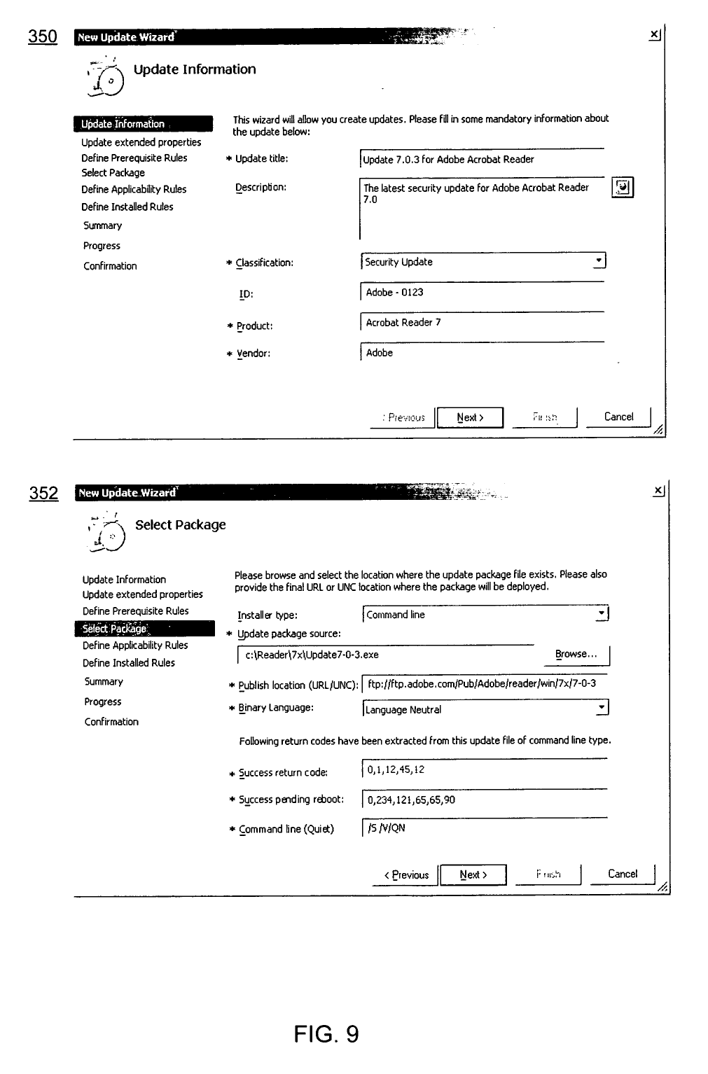

FIG. 4 shows an example of a main user interface 240 for an update management tool. Although the layout and appearance of the example user interface 240 is not important, the example shows some reasonable ways to allow a user to manage updates. The user interface 240 in FIG. 4 has a panel 242 on the left for organizing updates by vendor or publisher. A leaf 244 under a publisher can be selected to view or manipulate the corresponding update, as discussed later with reference to FIGS. 7 and 8. The user interface 240 may also have a mechanism such as action pane 246 for invoking functions of the tool 140. Example interfaces for create-update functions (update authoring, see FIGS. 9-10), import-update functions (see FIG. 6), and configuration functions (see FIG. 5) will all be discussed. Other portions of the main user interface 240 are self-explanatory.

FIG. 5 shows some interface elements 260, 262 for configuring update metadata imports. Elements 260, 262, as well as others, may be displayed in response to activation of the “Configure” element shown in FIG. 4. Panel 260 is used to designate or add a path of a file or URL that is to be imported. For example, if the “Add ULR” button is activated, then a widget 262 is displayed for entering a URL and optionally information about digital signing and publishing of the update when it is imported from URL inputted in widget 262. The information inputted for the URL may be stored, for example in repository 214. Multiple URLs or files may be inputted, as seen in the lower left hand version of panel 260. Actual importing may occur as part of the configuration process, or it may occur later with a separate “import” action.

FIG. 6 shows a process and interface elements for actually importing update metadata files identified previously by user input and/or identified automatically, for example by importing a set of update metadata that was previously imported. In response to selecting the “Import” action in FIG. 4, the user is allowed to choose 280 whether to manually or automatically import the updates. A summary of impending updates to be imported is displayed 282; see panel 284. The update metadata (internal and/or external) is imported 286. The tool 140 checks 288 signatures of the updates if it is so configured. Any update metadata or catalogs that are read but not properly signed may be displayed 290 for further confirmation; see panel 292. A summary 294 of the import process is shown 296. As shown in FIG. 6, the imported update metadata can be embedded in a package such as a CAB file, which might also include the actual bits for updating corresponding software.

FIG. 7 shows a process and user interface for viewing details about a software product with which a number of software updates may be associated. A user may select 312 a product, for example by clicking a product leaf 244 in the main user interface 240. In response, detail about the selected 312 product is displayed 314 in the center of the user interface 240. As seen in the example of FIG. 7, multiple updates can be associated with a program or product. Any details from the update metadata of the program/product's updates may be displayed. Also, a flag or element indicating whether an update is to be published into a master catalog may be displayed and modified.

FIG. 8 shows a process and interface for displaying detail of an update. A user selects 330 a particular update such as update 332 (either by selecting among listed updates, or searching for the update, etc.). In response, detail about the selected 330 update is displayed 334 in the user interface 240. Applicability rules of the selected 330 update can also be viewed. The user may modify or edit 336 the update or parameters associated with it.

FIGS. 9 and 10 show some user interface panels for authoring an update. The authoring process can be invoked by selecting the “Create Update” action in the main user interface 240. A number of stages of a wizard can be passed through to author an update (see the left hand side of panel 350; “Update”, “Define”, “Select”, etc.). Information about the new update is inputted by the user with panel 350. Other information-extended properties-might also include information about where to find an article describing the update, information about the severity or importance of the update, a support URL, information about the impact of the update, reboot behavior of a computer when the update is applied, and so on.

Panel 352 shows an example of how an update package can be selected. An update package is the set of information that is used to actually upgrade or update a particular software product or program. An update package may include binary executable files to replace currently installed files, or replacement libraries, or binary segments to be patched into an existing program file, new registry entries, system configuration changes affecting the program or software product, or other parts used to run a program. As can be seen in panel 352, selecting a package can involve information on where a package is located, how it is applied, and so on.

Other interface features of the update creation process are not shown in FIG. 9. A panel may be displayed for defining prerequisite rules, which are rules about the conditions under which the new update might be relevant. For example, if the Operating System version, the Operating System language or the processor architecture of a given system is such that an update would be considered for further applicability checks. Applicability rules can also be defined. Applicability rules can involve types of information similar to that of the prerequisite rules. However, prerequisite rules will usually be high level information about the host or platform to be scanned (OS type or version, processor architecture, language, etc.), whereas applicability rules will usually look at lower level conditions such as the existence or value of a configuration setting or registry key, the existence of a file, signs that the software product or program corresponding to the new update may exist on the target client, or other information for determining whether the update may be applicable or. Another panel may be displayed to define “installed rules”, which are rules that can be used to determine whether the update (the one being authored) has already been installed on a client computer.

The prerequisite rules, applicability rules, and installed rules can be defined using a rule definition interface similar to those shown in FIG. 10. FIG. 10 shows panels 370, 372 for creating rule terms. A rule term is some condition that can be tested for on a client computer. Various types of these conditions have been discussed above. The conditions may involve more than just an existence/non-existence condition. Conditions may involve a mathematical comparison or a regular-expression type of comparison (string matching), to name a few examples. A complex rule can be built up using rule terms. For example a rule may specify that both: a build number of a program must be greater than 1234 AND a file AcroRd32.exe must exist. Furthermore, rules can be named, saved, reused, and copied and modified.

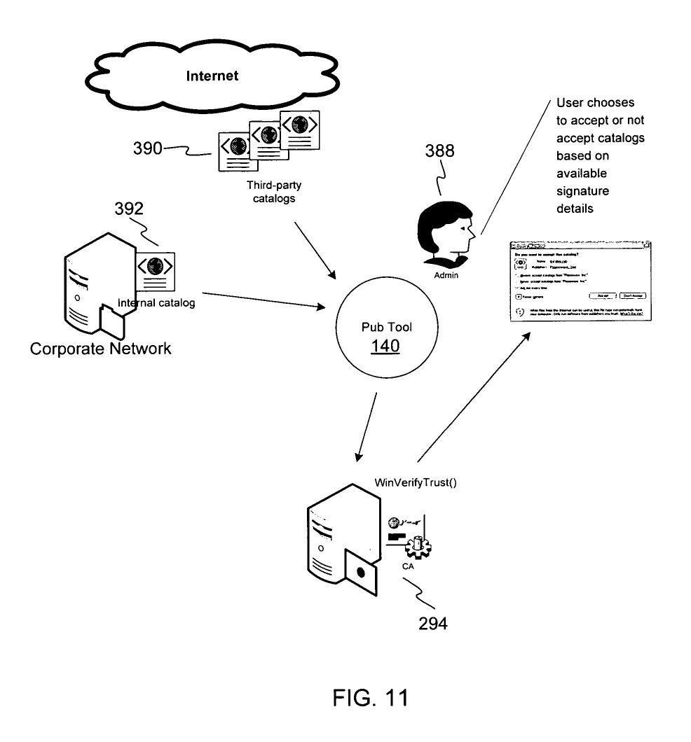

FIG. 11 shows a scheme for securing update catalogs generated with an update management tool. As discussed above, in one embodiment, a software update management tool may secure a third party update metadata or update catalog by checking to see that it has a digital certificate and verifying the certificate. First, an administrator 388 may configure the tool 140 to verify update catalogs. When the tool 140 imports third party catalogs 390 or even internal catalogs 392, digitally signed certificates attached thereto are authenticated by a registered certificate authority 394. The administrator can decide to accept an update or catalog even when a certificate is not found or authenticated.

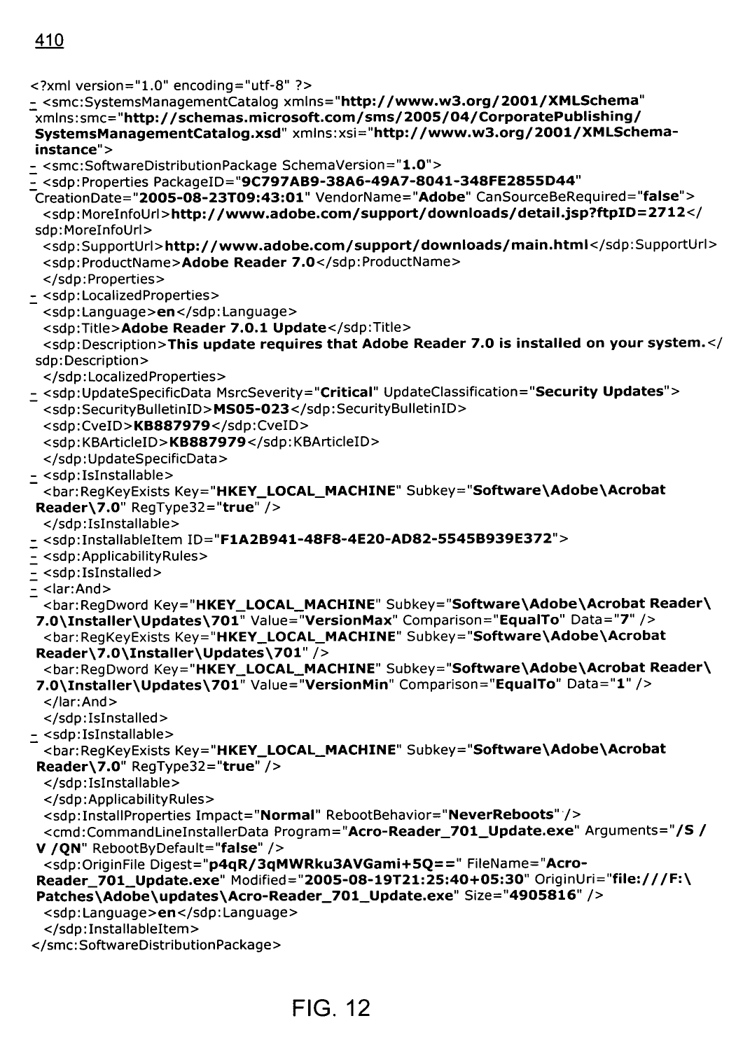

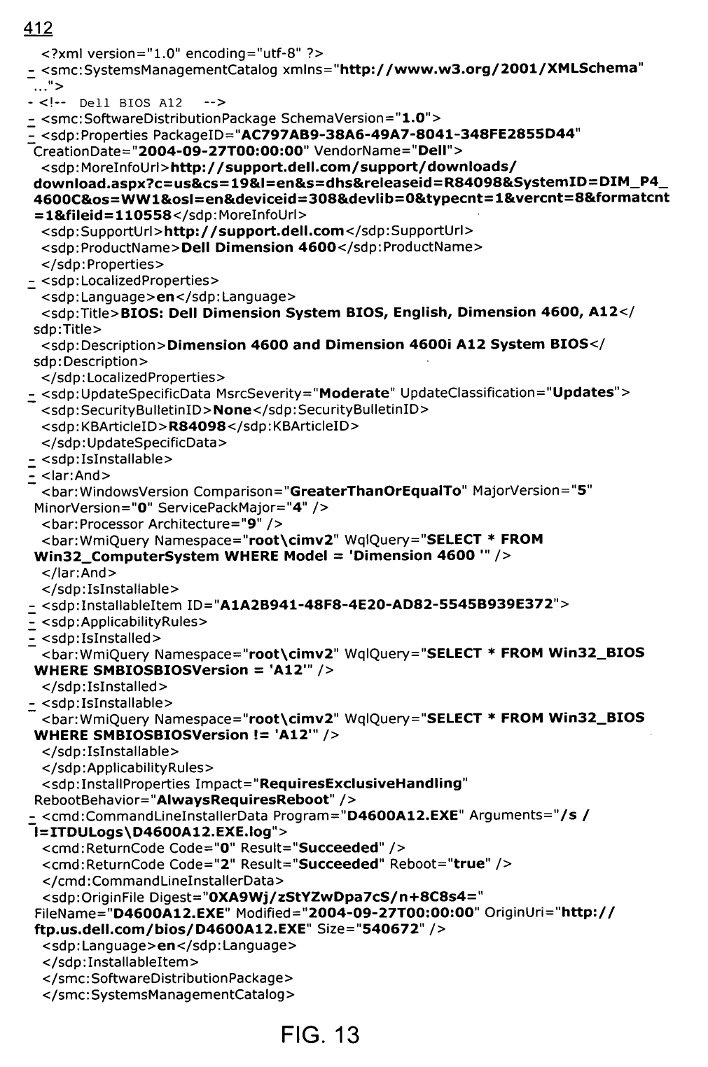

FIGS. 12 and 13 shows examples of update metadata or catalogs 410, 412. As mentioned above, update metadata can conform to a common schema adhered to by participants that share their update metadata across institutional boundaries. Such a schema may specify that a catalog has one or more updates “SoftwareDistributionPackages” in examples 410, 412), an update has one or more properties, for instance rules regarding applicability (and/or prerequisites, and/or existence of the update) and where to get the data for applying a patch or update that corresponds to the update metadata. A catalog with multiple updates will usually correspond to a particular software vendor. For example, update metadata 410 has update metadata relating to “Adobe Reader 7.0.1”, and might well have updates relating to other software products available from Adobe.

In sum, an update metadata catalog (whether built from imported and authored pieces of metadata, or whether written by hand), may include information about patches and applications, descriptive information such as what the update does, installation information such as how to install/uninstall the package for the update, scanning rules about whether the update is applicable to a particular machine (e.g., SQL server on XP Home Edition) and/or rules about whether the update is already installed, detection primitives such as MSI, MSP, or CBS based detection, Windows versions, files, registry data, WMI queries, and so on. These primitives can be built into complex detection rules using Boolean operators (and, or, not).

In conclusion, those skilled in the art will realize that storage devices used to store program instructions can be distributed across a network. For example a remote computer may store an example of a process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by using techniques known to those skilled in the art, all or a portion of the software instructions may be carried out by a dedicated circuit, such as a DSP, programmable logic array, or the like.

All of the embodiments and features discussed above can be realized in the form of information stored in volatile or non-volatile computer or device readable medium. This is deemed to include at least media such as CD-ROM, magnetic media, flash ROM, etc., storing machine executable instructions, or source code, or any other information that can be used to enable or configure computing devices to perform the various embodiments discussed above. This is also deemed to include at least volatile memory such as RAM storing information such as CPU instructions during execution of a program carrying out an embodiment.

1. A method of generating a software update catalog, the method comprising:
accessing a plurality of resource identifiers, each resource identifier identifying a location of a portion of update metadata corresponding to a respective software program or product, where the portions of update metadata include information for determining whether to apply their respective updates;
using the resource identifiers to import the portions of update metadata; and
generating the software update catalog based on the imported portions of update metadata.

2. A method according to claim 1, further comprising passing the software update catalog to an update management system that can use the update catalog to scan for updates identified in the catalog.

3. A method according to claim 1, wherein the importing comprises obtaining the portions of update metadata, via a network, from servers of different autonomous entities, institutions, or businesses.

4. A method according to claim 3, further comprising validating the imported portions of update metadata against a schema.

5. A method according to claim 1, further comprising validating digital signature certificates attached to the portions of update metadata and taking an action to avoid importing any portions that are not validated.

6. A method according to claim 1, where one or more portions of the imported update metadata are authored by one or more institutions, businesses, or enterprises other than an institution, business, or enterprise that is importing the portions of metadata, and where one or more other portions of the imported update metadata are authored by the importing institution, business, or enterprise.

7. A method according to claim 1, wherein a portion of update metadata includes a signature describing how to determine whether a computer is a candidate for being updated by an update patch corresponding to the portion metadata.

8. One or more computer-readable media storing information for a computer to perform a process, the process comprising:
displaying a user interface for authoring an update, where the user interface allows a user to define information that identifies the update and signature information by which a computer can be scanned to determine whether the update has been installed on the computer and/or whether the update is applicable to the computer; and
receiving a command from the user to publish the update, and in response generating a portion of update metadata that includes the information that identifies the update and that includes the scan information.

9. One or more computer-readable media according to claim 8, wherein the portion of update metadata is saved in a file tagged according to a standardized schema for structuring updates.

10. One or more computer-readable media according to claim 9, wherein the publishing causes the file to be made available such that it can be download by the public via the Internet.

11. One or more computer-readable media according to claim 8, wherein the process further comprises displaying a rule construction widget for building boolean expressions having boolean operators operating on terms, where the terms comprise indications of the installation of software, and where the signature information is comprised of one or more boolean expressions built with the rule construction widget.

12. One or more computer-readable media according to claim 8, wherein the process further comprises displaying an interface element that allows a user to identify an update package associated with the update being authored.

13. One or more computer-readable media according to claim 8, wherein the process further comprises displaying a user interface element with which a user can interact to define an update catalog by identifying for inclusion in the catalog the authored update metadata and update metadata provided by third party businesses, organizations, or institutions.

14. One or more computer-readable media storing an update catalog, the update information comprising:
catalog tags denoting that the update information is an update catalog and tagging information identifying the update catalog; and
update tags and individual updates demarked by the update tags, where an individual update comprises information by which a computer can be scanned to determine whether the individual update is applicable to the computer and information identifying the update and a software program, product, or installation that corresponds to the individual update.

15. One or more computer-readable media according to claim 14, wherein some of the updates correspond to software programs, products, or installations available from different businesses, organizations, or institutions.

16. One or more computer-readable media according to claim 15, wherein the updates that correspond to the software programs, products, or installations available from different businesses, organizations, or institutions are obtained from the same.

17. One or more computer-readable media according to claim 14, wherein the catalog further comprises tagged update package location information that indicates locations of update packages corresponding to the updates in the catalog.

18. One or more computer-readable media according to claim 14, wherein the updates further comprise tagged prerequisite information that indicates prerequisite conditions that must be satisfied before updates are scanned for.

19. One or more computer-readable media according to claim 14, wherein one or more updates include information indicating whether such updates require a computer to rebooted if a corresponding update package is applied.

20. One or more computer-readable media according to claim 14, wherein one or more updates include information indicating return codes that indicate success and/or failure of application of a corresponding update package.
